(19) United States
(12) Patent Application Publication
(10) Pub. No.: US 2010/0317797 A1
(43) Pub. Date: Dec. 16, 2010

(54) PARTICULATE CATALYST AND CATALYST/STABILIZER SYSTEMS FOR PRODUCING HIGH-MOLECULAR-WEIGHT HOMOPOLYESTERS AND COPOLYESTERS OF L-, D- OR D,L-LACTIC ACID

(75) Inventors: Gerald Rafler, Potsdam (DE); Jutta Rafler, Potsdam (DE); Andreas Windsperger, Maria Anzbach (AT); Robert Edlauer, Laa a.d. Thaya (AT); Josef Gass, Drosing (AT)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: JUNGBUNZLAUER AUSTRIA AG, WIEN (AU)

(21) Appl. No.: 12/742,185

(22) PCT Filed: Nov. 14, 2008
(86) PCT No.: PCT/AT2008/000412

§ 371 Date: Aug. 31, 2010

(30) Foreign Application Priority Data
Nov. 14, 2007 (AT) A 1837/2007

(51) Int. Cl. C08K 3/22; C08G 63/06; C08L 67/04; C08G 63/08

(52) U.S. Cl. 524/786; 528/361; 524/878; 524/779; 524/847; 528/354

(57) ABSTRACT

The invention relates to a method for the production of high-molecular homo- and Copolyesters of L-, D- and D,L-lactic acids that comprises the process steps of i) the polycondensation of a lactic acid or polytransesterification of esters thereof to a polymeric lactic acid, ii) the cyclizing depolymerization of the polymeric lactic acid to dilactides, and iii) the ring-opening polymerization of the dilactides or mixtures thereof with suitable comonomers, characterized in that in at least one of the process steps i) to iii), a particulate catalyst and/or a particulate stabilizer, each having an average particle diameter of 1 to 100 nm, is/are used in a heterogeneous reaction mixture.

The present invention relates to a method for the efficient production of polylactic acids of high molar mass and high optical purity (using chiral monomers) by selective catalysis, as well as polylactic acids produced by this method.

### State of the Art

International developments on the plastic market show that a poly-L-lactic acid (PLA) has the best prospects on the market for alternative plastics because of its typically thermoplastic character, the possibility of use-specific adaptation of the material properties by compounding and chemical modification typical for thermoplastics and especially heterochain polymers, its biogenic raw material base, and the polymer's biodegradability. It is obvious that there is a vast market with strong growth potential for this polymeric material in application areas that require only temporary stability and where recyclability is difficult, such as with
hygienic materials (baby diapers, incontinence products),
selected packaging means, especially dishes for fruit, meat and sausage products as well as fish,
diverse medical products with one-way character,
sheets for agriculture and forestry as well as plant containers.

With an appropriate molecular mass and, if necessary, stabilization, this plastic shows high sustainability and has also realistic prospects to become a substitute for conventional polyester materials in synthetic fiber materials used for high-quality functional clothing (sports, leisure wear) as well as polymer granulates for injection molding and extrusion molding for obtaining molded articles with long-term stability.

The polymer is produced in a multistep process involving biotechnological and chemical process steps, which mainly comprises:
hydrolyzing starch-containing substrates to glucose;
fermenting the glucose to L-lactic acid;
condensing to low-molecular poly-L-lactic acid;
cyclizing depolymerization to L,L-dilactide;
ring-opening polymerization of the L,L-dilactide to poly-L-lactic acid;
stabilizing and demonomerizing the polymer.

This multistep process for producing poly-L-lactic acid is described in numerous patents, particularly those to Cargill Inc. USA (see e.g. U.S. Pat. No. 6,277,951, U.S. Pat. No. 6,005,067, U.S. Pat. No. 5,357,035, U.S. Pat. No. 6,291,597, CA 2,128,509), Dainippon Ink & Chem. Japan (see e.g. U.S. Pat. No. 5,844,066, U.S. Pat. No. 5,616,657, U.S. Pat. No. 5,605,981, U.S. Pat. No. 5,403,897), Mitsui Toatsu Japan (see e.g. U.S. Pat. No. 5,194,473), Neste Oy Finland (WO 98/36008), Brussels Biotec (see e.g. GB 2,407,572, WO 98/02480, DE 69905016, U.S. Pat. No. 6,489,508, US 2004/0014991) or Shimadzu Japan (see e.g. U.S. Pat. No. 5,770,682, U.S. Pat. No. 5,866,677, JP 7206851).

The chemical process steps for producing L-, D- and D,L-polylactic acids, i.e.
polycondensation of lactic acid;
cyclizing depolymerization of the polylactic acid;
ring-opening polymerization of the diesters,
   may basically be accelerated by means of catalysts or initiators, the use of catalysts being necessary to obtain economical space-time yields in the process, or products that are of interest in the materials market. The reactions are based on different mechanisms so that different catalysts have to be selected for the activation of individual process steps.

The first chemical process step, polycondensation of lactic acid, is a typical AB-type polycondensation with OH and COOH groups on the monomer that comprises the cleavage of H₂O as low-molecular component and activation by an A_{AC}2 mechanism. Corresponding to the reaction steps typical for A_{AC}2 reactions, a primary addition of electrophilic catalysts (preferably protons, but metal and non-metal cations are also possible) to the carbonyl group is followed by the addition of nucleophilic reaction partners to the carbonyl carbon and the elimination of the original substituents. According to the state of the art, an aqueous L-lactic acid with a lactic acid content >80%, as obtained by the work-up of fermentation broths, is used for producing low-molecular poly-L-lactic acids. In the presence of “free” water, the proton activity of lactic acid is sufficient for catalyzing polyesterification. However, due to insufficient proton activation because of low dissociation of carboxyl groups, highly concentrated or anhydrous lactic acids require suitable catalysts. Also when producing poly-L-lactic acids of higher molar masses, suitable catalysts have to be used because the required COOH group concentration decreases rapidly with increasing molar masses. At the same time, the autocatalytic effect of the COOH groups decreases. For catalyzing polyesterification in the presence of metal compounds (halides, carboxylates, alkoxides), proton catalysis by alkoxo acids or acidic lactato complexes formed by metal ions and lactic acid according to Scheme 1 is assumed (G. Rafler, Praxis der Naturwissenschaften (PdN-Chis) 54H7, 12 (2005) and G. Rafler et al., Acta Polymerica 44, 315 (1988)). Here, it is to be taken into account that these catalysts are also show activity in an anhydrous polymer melt. Consequently, starting products of higher molecular weights may also be used for the subsequent process step, as has been shown by the applicant in the copending patent application “Verfahren zur Herstellung zyklischer Diester von L-, D- and D,L-Milchsäure”. Synthetic D,L-lactic acids, which may be produced anhydrously by this method, may also be efficiently polycondensed in this way. At the same time, these catalysts may as well be used for the polycondensation of lactic acid esters, which also takes place in an anhydrous medium.

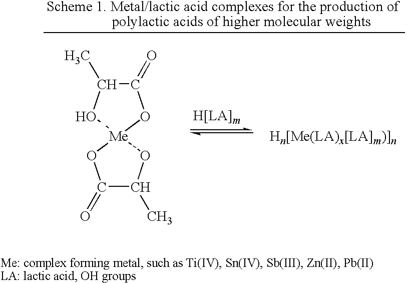

Cyclizing depolymerization, the second chemical process step of the overall process, is mainly based on the thermodynamic concepts of ring/chain equilibria of cyclic esters (lactones) or amides (lactames) (see for example H. -G. Elias: Makromoleküle, 5^{th} ed., Hüthig & Wepf (1999)). Contrary to an autocatalyzed polycondensation of lactic acid, all described methods use catalysts, preferably tin(II) salts and tin(II) oxide, for accelerating the cyclizing depolymerization of polylactic acids to dilactides. The activation of this elimination reaction is achieved by the addition of electrophilic catalysts, followed by the addition of the terminal nucleophilic OH group of a polyester to the ester carbonyl carbon and elimination by cyclization according to Scheme 2. Here, intermediate macrocycles may initially be formed, which are then further cleaved to obtain dimeric cycles. Since depolymerization is, because of the molar mass of the polymer, conducted in a substantially anhydrous system of the polymer melt, catalysis by Lewis cations of the metal compounds used or still present from the polycondensation step is dominant.

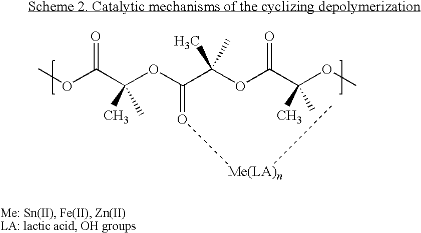

Most authors of scientific literature classify the ring-opening polymerization of dilactides as a polymer-forming reaction of the insertion type that includes the incorporation of a monomer into the polymer/catalyst bond. In a polyinsertion mechanism for chain growth (H. -R. Kricheldorf, Macromol. Symp. 153, 55 (2000) or Chemosphere 43, 49 (2001)), the dilactide is inserted into the polymer/metal bond under acyl-oxygen cleavage (for a review on lactone and lactide polymerization see A. Löfgren et al., J. Macromol. Sci.—Rev. Macromol. Chem. Phys. C 35, 379 (1995)). This insertion requires the polymer/metal bond to have a certain relative stability. Primary activation occurs by the attachment of Lewis acid to the exogenous carbonyl oxygen (Scheme 3).

However, as a result of the parallel inter- and intramolecular chain/chain exchange reactions, the mechanism is probably more complex, with polyinsertion constituting an “idealized” case.

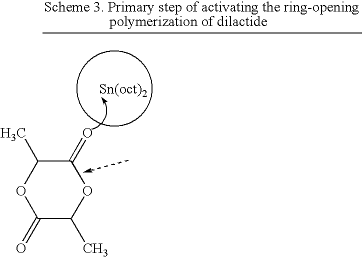

In contrast to most known polymerization processes for olefinic or vinyl monomers, monomer turnover and molar mass run in parallel in the ring-opening polymerization of cyclic esters and diesters. A high monomer turnover usually corresponds to a high molar mass (see G. Rafler, J. Lang, M. Jobmann, I. Bechthold, Macromol. Mater. Eng. 286, 761 (2001)). Furthermore, it is to be noted that the tin(II)-containing catalysts mainly used result in a polymerization course with a distinct extremal character that is hard to manage technically with regard to the molar mass of the polymer (U.S. Pat. No. 6,657,042). This means that the object has to be high turnover with short polymerization times in order to remain close to the molar mass maximum and to keep down the influence of catalyst- and temperature-dependent degradation processes.

For reducing the influence of process- and catalyst-related depolymerization or degradation processes, it was proposed to reduce tin(II) concentration by using catalyst combinations (U.S. Pat. No. 6,657,042) or, particularly, different forms of stabilization with preferably phosphorus stabilizers (WO 03/87191, DE 69328822, EP 0,615,532, DE 69330046).

Irrespective of technological or apparatus-related process variations, especially with regard to the catalysts used, the above patent documents describe homogenous catalytic processes. This is general practice in molten-stage methods, in which polymers are formed or in which polymers are reacted. In contrast to gas or low-viscosity liquid phase reactions, heterogeneous catalytic processes in polymer melts are hard to manage technically because of high melt viscosities, lacking separability of the catalyst carrier, high reactant concentrations, etc.

### OBJECT OF THE INVENTION

Against the background of the state of the art described above in the production of polylactic acids used as polymeric materials for packaging purposes or high-quality synthetic fibers, in various consumer products for single or temporary use or for extra- or intracorporeal medical uses, the object of the invention is to propose an economically efficient method for the production of these sustainable polymers that not only allows for the production of all process-specific intermediate and end products with improved yields, high purity and improved use-specific properties, but also guarantees high safety during the implementation of all steps of the process and stability of the intermediate and end product parameters set.

### DESCRIPTION OF THE INVENTION

According to the invention, this is achieved by means of a method for the production of high-molecular homo- and copolyesters of L-, D- or D,L-lactic acids that comprises the process steps of i) the polycondensation of a lactic acid or polytransesterification of esters thereof to a polymeric lactic acid, ii) the cyclizing depolymerization of the polymeric lactic acid to dilactides, and iii) the ring-opening polymerization of the dilactides or mixtures thereof with suitable comonomers, and is characterized in that in at least one of the process steps i) to iii), a particulate catalyst and/or a particulate stabilizer, each having an average particle diameter of 1 to 100 nm, is/are used in a heterogeneous reaction mixture. Preferably, all chemical process steps for the production of L-, D- or D,L-polylactic acids comprise the use of a catalyst and/or a stabilizer of a particulate material within the above size range.

Regarding the catalysts or stabilizers with average particle diameters of 1 to 100 nm, catalyst particles within this size range have an activity comparable to that of dissolved catalysts. In the case of activation on molten-phase macromolecules, catalyst particles in the lower nanometer range thus have a similar behavior to dissolved catalyst molecules, especially when, according to preferred embodiments of the invention, an agglomeration of the nanoparticles after dispersion is prevented by suitable measures, such as appropriate selection of the dispersion medium, adjustment of the concentration, surface modification of the particles etc. In addition, the particles may be separated from the basically heterogeneous reaction mixture more easily than homogenously dissolved catalysts or stabilizers, as long as their agglomeration has been actively brought about.

Preferably, the particulate catalyst or stabilizer has an average particle diameter of 3 to 20 nm. A smaller particle diameter allows more atoms or functional groups near the surface relative to the overall atom number, which allows for a more effective catalysis.

In preferred embodiments of the invention, the particulate catalyst or stabilizer comprises a particulate inorganic oxide as carrier material. Because of their broad availability and their low costs, inorganic oxides are well suited as carrier materials for catalysts and stabilizers. Preferably, the particulate inorganic oxide is silica, alumina or a mixture thereof since these oxides are readily available and cheap and lead to excellent results when used with catalysts. For example, the AEROSILS and AEROXIDS of Degussa AG may be used.

According to the invention, carrier materials with a similar hydrophilicity or hydrophobicity as the catalyst or stabilizer are preferably used. This means that with hydrophobic catalyst compounds, the carrier material is preferably also hydrophobic, and with hydrophilic catalyst compounds, the carrier material is preferably also hydrophilic. This leads to a better adhesion of the catalysts/stabilizers to the carrier. The desired hydrophilicity or hydrophobicity of the carrier may be adjusted by means of surface modification.

In preferred embodiments of the inventive method, the particulate catalyst comprises at least one organic or inorganic metal compound adsorbed to the carrier material because such compounds have been shown to have good catalytic activity in reactions for producing polylactic acids. Here, the at least one organic or inorganic metal compound can, depending on the process step, be selected from titanium, zirconium, tin, zinc, lead and antimony compounds. Preferably, Ti(IV), Zr(IV), Sn(IV), Sn(II) and Zn(II) compounds can be used. Especially well suited carrier materials for these catalysts selected according to the process steps are AEROSILS and AEROXIDS of Degussa AG because of their available size ranges and their hydrophilic or hydrophobic surface modification. Depending on the interface properties of the specific catalysts, hydrophobic carrier materials are available for more hydrophobic catalysts, such as Sn(II) octonoate, Sn(IV) alkoxide or Sn(Phen)₄, to provide for optimal adsorption of the catalyst. On the other hand, for hydrophilic catalysts, such as Sn(II) chloride, Ti(IV) or Zr(IV) chelate complexes, appropriate carrier materials with hydrophilic surface properties are used. These metal compounds result in excellent yields in the different process steps.

The ratio of the components in the catalyst particles can vary as a result of the big inner and outer surface area and their distinct adsorption capacity in a big area of 300:1<carrier/catalyst<1:3. With that, an optimal tuning of the catalyst for method related as well as material specific needs is possible.

The extreme adsorptive capacity of the AEROSILS and AEROXIDS also allows for a parallel provision of cocatalysts or stabilizers that may be required or desired.

Catalyst or stabilizer particles are produced by the adsorption of a dissolved catalyst or stabilizer in a solvent that also has appropriate dispersion properties for the AEROSILS and AEROXIDS. The catalyst particles can be dosed directly from these dispersions or, after isolation and drying, as solids.

Preferably, the particulate catalyst used in process step i), i.e. during polycondensation of L-, D- or D,L-lactic acids or polytransesterification of its esters, has, being a metal compound adsorbed to the carrier, hydrolysis-stable complexes of titanium or zirconium with the following structure:

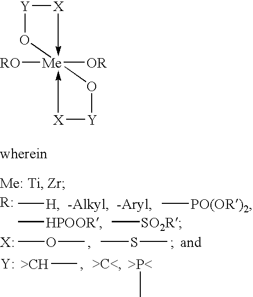

These metal compounds have been shown to be extremely effective. The catalytically active titanium compounds for particle production can also be a titanium alkoxide, particularly titanium tetrabutylate, or an oligotitanate as well as a titanium chelate, such as dihydroxy-bis-(ammoniumlactato)-titanate (Tyzor LA, DuPont) (Scheme 4, center), isopropyl-tri(dioctylphosphato)-titanate (KR 12, Kenrich Petrochemicals), isopropyl-tri(dioctylpyrophosphato)-titanate (KR 38 S, Kenrich Petrochemicals) (Scheme 4, right) and diisopropyl-bis-(acetylacetonato)-titanate (Scheme 4, left).

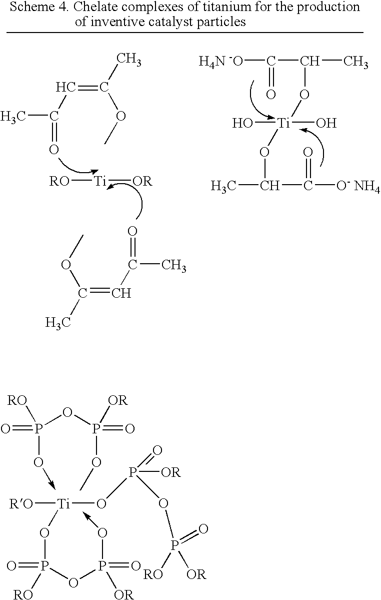

The titanium or zirconium complexes can have further functionalities on the selected ligands. These can, for example, contribute to improving catalysis and thus to higher yields, but also to the attachment to a carrier material, the dispersion of the catalyst in a medium etc.

In alternative preferred embodiments of the invention, the particulate catalyst has a hydrolysis-stable chelate complex of titanium or zirconium in combination with a tin(II)-halide as the metal compound adsorbed to the carrier, which allows for a distinct improvement of the catalytic activity.

In process step ii), the cyclizing depolymerization of poly-L-, poly-D- or poly-D,L-lactic acids, the particulate catalyst preferably has tin(II)-halide or tin(II)-carboxylate as the metal compound adsorbed to the carrier. These lead to a higher dilactide yield.

In process step iii), the ring-opening polymerization of cyclic esters and diesters, the particulate catalyst preferably has organic tin(II) or tin(IV) compounds as the metal compound adsorbed to the carrier since these are very effective catalysts for ring-opening polymerizations. More preferably, the particulate catalyst has an organic tin(II) or tin(IV) compound in combination with a titanium(IV) alkoxide as the metal compound adsorbed to the carrier in this process step since a combination of these organic metal compounds allows for a quicker ring-opening polymerization.

Generally, it is to be noted that for an increase of the catalytic activity and for a technological simplification of the process, the titanium compounds may, in the case of similar interface properties, be applied onto the AEROSIL- or AEROXID-type nanoparticles together with tin(II)-halides, tin(II)-carboxylates or tin(IV)-alkoxides or with compounds of tin or antimony. Tin(II) and, to a lesser extent, tin(IV) compounds have lower catalytic activity in polycondensation reactions than titanium compounds, are, however, more active depolymerization and polymerization catalysts. By means of fixation it is possible to use Ti/Sn combinations in the polycondensation step. In the method of the present invention, catalyst optimization thus provides optimal preconditions for a technological and/or apparatus-related process integration while preserving the advantages of the method that result from the activation of a polycondensation of lactic acid. The use of the Ti/Sn nanoparticles also allows the preparation of higher molecular polylactic acids for optimizing the depolymerization process and for producing raw dilactides with higher purity and yields (see Tables 1-3).

Due to the adsorption, the nanoparticulate titanium, tin and zinc catalysts have, irrespective of the structure of the compound, higher hydrolytic and thermal stabilities so that lactic acids with a higher water content may also be directly polycondensed with these catalysts or catalyst combinations, the accelerated polycondensation leading to the additional effect that the volatility of lactic acid during dehydration and polycondensation is reduced.

The use of inventive catalysts or catalyst combinations fixed on nanoparticles allows for the production of polylactic acids of higher molecular weights with number-average molar masses of up to 10,000 g/mol and higher process rates by polycondensation at mild temperatures, which acids are then supplied to the depolymerization step.

TABLE 1
Mₙ values of polycondensates of L-lactic
acid as dependent on the catalyst used

| | 10⁴ | Mₙ |
|---|---|---|
| Catalyst | [mol/mol] | [g/mol] |
| Without | | 550 |
| Tyzor LA, dissolved | 1.0 | 2300 |
| Tyzor LA, dissolved | 3.0 | 3500 |
| Tyzor LA, nanoparticulate | 1.0 | 2500 |
| Tyzor LA, nanoparticulate | 3.0 | 3700 |
| Tyzor LA, nanoparticulate | 6.0 | 5000 |
| Tyzor LA + SnCl₂, nanoparticulate | 4.0/3.0 | 6000 |

Polycondensation conditions: T: 180° C.; p: 1.6 kPa; t: 4 h.

The nanoparticulate catalysts claimed may also be used for activating the polytransesterification of lactic acid esters to polylactic acids according to Eq. (1):

n CH₃CH(OH)COOR [symbol] [—OCH(CH₃)CO-]ₙ+(n−1)ROH Eq. (1)

wherein R is —C₂H₅, —C₃H₇ or —C₂H₄OH.

These catalysts also accelerate the polycondensation of lactic acid/lactic acid ester mixtures. Lactic acid esters constitute an alternative to classic methods for purifying lactic acids by membrane or precipitation processes. They can be separated from the raw lactic acid by distillation after transesterification.

Nanoparticles may also be used in the depolymerization step for activating the formation of dilactides. For this purpose, AEROSILS or AEROXIDS are loaded from a solution with tin(II)-halides or tin(II)-carboxylates, which according to the state of the art are used as catalysts for ring-opening polymerization as well as cyclizing depolymerization in almost all published methods (see the US, GB and CA patent documents already mentioned), in analogy to the procedure used for nanoparticulate polycondensation catalysts. Depending on the technology chosen, the tin-containing nanoparticles of the polylactic acid melt may be added, after completion of the polycondensation or already during the polycondensation step, in the form of Ti/Sn catalyst combinations. According to the state of the art, depolymerization of the polylactic acids was conducted at a temperature of 180 to 240° C. in a vacuum of 133 Pa under separation of the formed dilactide via a heated column. Also according to the state of the art, the raw lactide may be purified by distillation, e.g. by rectification, or by crystallization from the melt or a solution.

Polyesters of higher molecular weights of L-, D- and D,L-lactic acids produced according to the invention form the corresponding dilactide with a higher yield and higher purity as well as with a higher rate (see Tables 2-4). The molar mass is indirectly proportional to the end-group concentration. This means that with higher molar masses, less OH and COOH end groups are available for rate-inhibiting and yield-reducing parallel reactions of the depolymerization. Consequential reactions of these undesired parallel reactions are also reduced. In particular, water formed during esterification may hydrolyze previously formed dilactides in the melt or in the distillates to linear dimers or lactic acid (Scheme 5).

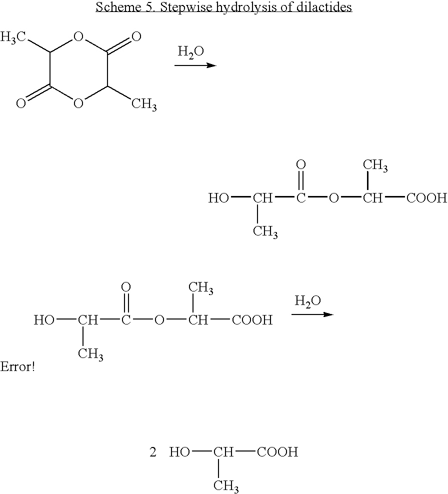

The amount of water inherently “bound” in the end groups that is potentially available for dilactide hydrolysis is related to the molar mass and the polymerization degree as shown in the Equations (2) and (3). According to Eq. (2), (n−1) moles of water are formed from n moles of lactic acid during polycondensation. Considering the connection between number-average polymerization degree and reaction progress degree in Eq. (3a) and (3b), this means, for example, that 900 g (10 mol) of an anhydrous lactic acid result in 162 g of water, correspondingly 81 g in the case of dimerization, or approx. 146 g when the linear decamer with Mₙ=738 g/mol is produced. When a linear oligomer with Mₙ=3,000 g/mol is produced, approx. 158 g of water have to be removed from the system for the same amount of lactic acid. Even after transition of Pₙ=10 to Pₙ=41.6, 12 g of water are still available for dilactide hydrolysis. This corresponds to a hydrolysis potential of 0.67 mol/mol, when the dilactide is separated and worked up.

n CH₃CH(OH)COOH [symbol] [—OCH(CH₃)CO—]ₙ+(n−1)H₂O Eq. 2

Pₙ=1/(1−p) Eq. 3a

p=1−1/Pₙ Eq. 3b

U.S. Pat. No. 6,277,951 states that in the case of higher molar masses, racemization in the form of a generation of meso-dilactides increases. Thus, the meso-dilactide content is approx. 5.3% when a starting oligomer with Mₙ=520 g/mol is used. An increase of the molar mass of the pre-polymer to 2,500 g/mol leads to a parallel increase of the meso-dilactide content in the distillate to approx. 11%. In addition, it is stated that cations generally increase the formation of meso-dilactides.

COOH group concentration and angle of rotation reflect the purity of a raw lactide, wherein the COOH group concentration is directly indicative of linear oligomers, preferably lactoyl lactic acid. They can be formed by ester-typical transesterification reactions with the involvement of the end groups as well as by hydrolysis of the dilactide. The optical activity, measured by means of the angle of rotation, is indicative of chemical as well as optical impurities of the dilactide.

TABLE 2
COOH concentration in a raw L,L-dilactide as dependent on
the catalyst type and the molar mass of the pre-polymer

| Mₙ [g/mol] | Catalyst | [COOH] [mmol/g] |
|---|---|---|
| 550 | SnCl₂, dissolved | 1.20 |
| 800 | SnCl₂, dissolved | 0.75 |
| 3500 | SnCl₂, dissolved | 0.21 |
| 3700 | SnCl₂, nanoparticulate | 0.14 |
| 5000 | SnCl₂, nanoparticulate | 0.08 |
| 6000 | SnCl₂, nanoparticulate | 0.05 |

Depolymerization temperature: 200° C.

TABLE 3
Angle of rotation of the raw L,L-dilactide as dependent on the
catalyst type and the molar mass of the pre-polymer
Depolymerization temperature: 200° C.

| Mₙ [g/mol] | Catalyst | [α] [deg] |
|---|---|---|
| 550 | SnCl₂, dissolved | −235 |
| 800 | SnCl₂, dissolved | −247 |
| 3500 | SnCl₂, dissolved | −255 |
| 3700 | SnCl₂, nanoparticulate | −257 |
| 5000 | SnCl₂, nanoparticulate | −260 |
| 6000 | SnCl₂, nanoparticulate | −259 |

In comparison, the angle of rotation of an L,L-dilactide purified according to the state of the art is −282°. It is clearly shown that a higher molecular weight leads to a purer product.

The effective rate constants of the depolymerization determined are very complex and are a result of the overlap of the chemical reactions taking place in the system with the mass transfer of the dilactide from the melt into the gas phase or its condensation to a crystalline solid. Considering this dependence on the system, Table 4 shows the relative rates for the selected experimental method.

TABLE 4
Relative reaction rate of dilactide formation (with regard
to SnCl₂, dissolved) as dependent on the catalyst type

| Catalyst | Rel. process rate |
|---|---|
| SnCl₂, dissolved | 1.0 |
| SnCl₂, nanoparticulate | 1.4 |
| SnO, dissolved | 0.9 |
| Sn(oct)₂, nanoparticulate | 1.5 |
| Sn(C₂O₄), nanoparticulate | 1.4 |

Depolymerization temperature: 200° C.
Mₙ of the pre-polymer: 3700 g/mol

According to the invention, the polymerization step also uses tin carboxylates fixed on AEROSIL or AEROXID nanoparticles as polymerization catalysts. The ring-opening polymerization of the dilactides (Scheme 6) was conducted discontinuously under laboratory conditions in a glass apparatus with a screwed blade stirrer and continuously in a twin-screw extruder with a screw design specifically adjusted to this mass polymerization. The course of the polymerization was observed via monomer turnover and molar masses of samples taken (Tables 6 and 7). In Table 5, the polymerization course is shown in comparison to Sn(oct)₂ dissolved in a monomer melt.

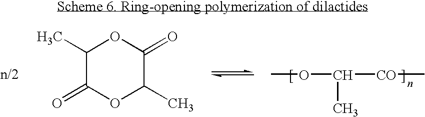

Ring-opening polymerization is a process proceeding very quickly in which the equilibrium monomer turnover is determined by polymerization temperature and catalyst concentration. Under technically relevant conditions, the equilibrium turnover is practically reached after only a few minutes. As shown in DE 10113302 and DE 10216834 as well as U.S. Pat. No. 6,657,042, the course of the molar mass over time is characterized by a distinctly extremal character of the M_{n,w}/t function when the experiment is conducted batch-wise. The use of catalyst-containing nanoparticles does not only lead to a leveling off of this extremal function, but also allows for the production of products of higher molecular weights. This difference in the M_{n,w}/t course is especially advantageous for the technological manageability of discontinuous processes. Possibilities for the synthesis of polylactic acids of higher molecular weights are of general interest since heterochain polymers of higher molecular weights require less stabilization efforts and thermoplastic processing is less problematic. With plastics of higher molecular weights, the inevitable molar mass reduction during deformation has a less drastic impact on the mechanical properties of the final product.

TABLE 5
Monomer turnover and number-average molar
mass of the polymerization of L,L-dilactide

| Time [min] | Turnover [%] | Mₙ [g/mol] |
|---|---|---|
| 2.5 | 40.0 | 88,000 |
| 5.0 | 80.0 | 99,500 |
| 7.5 | | 94,000 |
| 10 | 86.0 | 83,500 |
| 15 | 89.0 | 77,000 |
| 20 | 91.5 | 76,000 |
| 25 | 92.0 | |
| 30 | 95.5 | 73,000 |
| 40 | 96.0 | 73,000 |

Polymerization temperature: 195° C.
Catalyst: Sn(oct)₂, dissolved in monomer melt, concentration: 1*10⁻⁴ mol/mol

TABLE 6
Monomer turnover of the polymerization of L,L-dilactide
as dependent on the catalyst concentration

| | Turnover [%] | Turnover [%] | Turnover[%] |
|---|---|---|---|
| Time | 0.5*10⁻⁴ | 0.75*10⁻⁴ | 1.0*10⁻⁴ |
| [min] | [mol/mol] | [mol/mol] | [mol/mol] |
| 2.5 | 16.0 | | 35.0 |
| 5.0 | 40.0 | 56.0 | 78.5 |
| 7.5 | 50.0 | | |
| 10 | 60.0 | 78.0 | 86.0 |
| 15 | 72.0 | 84.0 | 90.0 |
| 20 | 77.0 | 86.0 | 91.5 |
| 25 | 81.5 | 89.0 | 95.0 |
| 30 | 88.5 | 91.5 | 95.5 |
| 40 | 89.5 | 94.5 | 96.0 |

Polymerization temperature: 195° C.
Catalyst: Sn(oct)₂ nanoparticles

TABLE 7
Development of the number-average molar mass during polymerization
of L,L-dilactide as dependent on the catalyst concentration

| | Mₙ [g/mol] | Mₙ [g/mol] | Mₙ [g/mol] |
|---|---|---|---|
| Time | 0.5*10⁻⁴ | 0.75*10⁻⁴ | 1.0*10⁻⁴ |
| [min] | [mol/mol] | [mol/mol] | [mol/mol] |
| 2.5 | 36,000 | 43,000 | |
| 5.0 | 50,000 | 67,000 | 109,500 |
| 7.5 | 64,500 | 78,000 | 99,000 |
| 10 | 62,000 | 74,500 | 93,500 |
| 15 | | | 87,000 |
| 20 | 60,000 | 71,000 | 86,000 |
| 25 | 61,500 | 66,500 | |
| 30 | 58,000 | 62,500 | 83,000 |
| 40 | 55,500 | 60,000 | 83,000 |

Polymerization temperature: 195° C.
Catalyst: Sn(oct)₂ nanoparticles

As already explained with regard to the polycondensation step, in the inventive method the polymerization step can also comprise the use of catalyst combinations that allow a gentler production of polylactic acid. Especially established catalyst systems based on tin(II) carboxylates and titanium alkoxides, as for example described in DE 10113302 and U.S. Pat. No. 6,657,042, can be optimally combined by a joint fixation on AEROSIL- or AEROXID-type nanoparticles.

According to the present invention, a nanoparticulate stabilizer may be used which preferably comprises at least one phosphorus compound or complexing agent for tin(II) and tin(IV) compounds that are adsorbed to a carrier material. Due to their molecular structure these are especially well suited for adsorption to nanoparticles.

Preferably, the at least one phosphorus compound is a phosphinic acid or a derivative thereof, and the complexing agent for tin(II) and tin(IV) compounds is tropolone or a derivative thereof. Due to their structure-dependent hydrophobic and hydrophilic molecular centers, these are especially well suited for a stabile adsorption to AEROSILS and thus for use in the form of nanoparticles. Especially preferred, the phosphinic acid or its derivative are selected from alkyl and aryl phosphinic acids, most preferably 9,10-dihydro-9-oxa-10-phosphaphenanthrene-10-oxide. These are commercially available and are characterized by particularly good stabilizing properties.

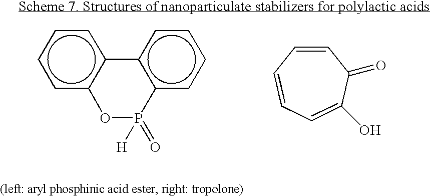

In the method of the invention, particle size, particle loading, interface properties of the loaded particles, and particle concentration allow controlling molecular parameters such as molar mass and molar mass distribution as well as, in the case of copolymers, composition. Thus, desired materials can be easily produced. Examples of the impact of catalyst concentration on the monomer turnover and the number-average molar mass are shown in Tables 6 and 7.

With the inventive method, polyesters with molar masses Mₙ of more than 150,000 g/mol having a molecular polydispersity M_{w}/Mₙ between 1.6 and 2.5 can be produced. Such high-molecular polyesters with a uniform molar mass distribution are practically inaccessible by means of conventional methods.

Furthermore, structurally equal or structurally different comonomers can be copolymerized. In this way, the inventive method also allows for a simple production of high-molecular homopolymers of the stereoisomeric dilactides or copolymers with extremely variable compositions. For L,L-dilactide, the structurally equal comonomers for copolymerization may be D,D- or meso-dilactide, suitable structurally different comonomers are for example diglycolide, trimethylene carbonate or ε-caprolactone. In this way, heteropolymers with the desired properties can be produced.

As mentioned above, the method can be conducted in a partially or completely discontinuous way in stirred reactors or kneaders with discharge screws. These are simple apparatus-related requirements for the production process. In another embodiment, the complete method can be conducted continuously in twin-screw extruders. This has the advantage that polymers are produced regularly without discontinuation of the production process, which might result in higher molar masses.

For a continuous ring-opening polymerization in a twin-screw extruder, a monomer/catalyst particle mixture was volumetrically dosed and delivered to the extruder. Furthermore, the apparatus set-up allowed a gravimetrical dosing of stabilizers as well as vacuum demonomerization. In view of the desired molecular parameters of the polyester (molar mass, molar mass distribution) and a stabilization of the final product, the reactive extrusion conditions as well as the specific screw design could be optimally adapted within a technologically relevant range. Table 8 shows a characteristic molar mass profile over a long-term trial run.

TABLE 8
Polymerization of L,L-dilactide in a twin-screw extruder

| Time [min] | Mₙ [g/mol] | M_{w} [g/mol] |
|---|---|---|
| 30 | 94,000 | 197,500 |
| 60 | 103,000 | 215,000 |
| 90 | 105,000 | 219,000 |
| 120 | 107,000 | 220,500 |
| 150 | 111,500 | 221,000 |
| 180 | 110,500 | 221,000 |
| 210 | 113,000 | 222,000 |
| 240 | 107,000 | 220,500 |
| 300 | 109,500 | 217,500 |

Catalyst: 3*10⁻⁴ mol/mol Sn(oct)₂ on AEROSIL R106
Temperature profile: 7 heating zones 175-205° C.

In a second aspect, the invention also relates to polylactic acids produced according to the inventive method.

The invention will be described in the following examples, which are provided for illustration only and not for limitation.

### EXAMPLES

### Example 1

For producing catalyst or stabilizer particles, solutions of catalysts or stabilizers in toluene, acetone, isopropanol or ethylene glycol are vigorously stirred with AEROSIL or AEROXID by means of a dispersion disc, followed by the evaporation of the solvent or dispersing agent under normal pressure or vacuum. With the very fine silica, mixed, or alumina of particle sizes <10 or <15 nm listed in Tables 9 and 10, the mass ratio of oxide to catalyst or stabilizer is varied between 1:1 and 4:1. With catalyst dosing as dispersion, redispersion is conducted by short-term mixing with an intensive agitator (Ultra-Turrax type) or in an ultrasonic bath.

TABLE 9
Selected examples of nanoparticulate catalysts for
the production of poly-L-, -D- and -D,L-lactic acids
from L-, D- and D,L-lactic acids, respectively

| Catalyst | | | | Process |
|---|---|---|---|---|
| example | Carrier material | Catalyst | Solvent | step |
| 1.1 | AEROSIL R 106 | KR 12 | toluene | i) |
| 1.2 | - ″ - | KR 38S | toluene | i) |
| 1.3 | - ″ - | DAT | toluene | i) |
| 1.4 | AEROSIL 300 | Tyzor LA | isopropanol | i) |
| 1.5 | - ″ - | Tyzor LA | acetone | i) |
| 1.6 | AEROSIL COK 84 | KR 38S | toluene | i) |
| 1.7 | - ″ - | KR 12 | toluene | i) |
| 1.8 | - ″ - | Tyzor | isopropanol | i) |
| | | LA/SnCl₂ | | |
| 1.9 | AEROXID Alu C | Tyzor LA | isopropanol | i) |
| 1.10 | AEROSIL 300 | Tyzor | isopropanol | i) |
| | | LA/SnCl₂ | | |
| 2.1 | AEROSIL 300 | SnCl₂ | acetone | ii) |
| 2.2 | AEROSIL 380 | SnCl₂ | acetone | ii) |
| 2.3 | AEROSIL R 106 | Sn(oct)₂ | toluene | ii) |
| 2.4 | AEROXID Alu C | SnCl₂ | isopropanol | ii) |
| 3.1 | AEROSIL R 106 | Sn(oct)₂ | toluene | iii) |
| 3.2 | AEROSIL COK 84 | Sn(oct)₂ | toluene | iii) |
| 3.3 | AEROXID Alu C | Sn(oct)₂ | toluene | iii) |
| 3.4 | AEROSIL R 106 | Sn(Phen)₄ | toluene | iii) |
| 3.5 | AEROSIL COK 84 | Sn(Phen)₄ | toluene | iii) |
| 3.6 | AEROSIL R 106 | Sn(oct)₂/TTB | toluene | iii) |

i): polycondensation of lactic acid
ii): cyclizing depolymerization
iii): ring-opening polymerization
DAT: diisopropyl-bis-(acetylacetonato)-titanate (see Scheme 4)
TTB: titanium tetrabutylate

TABLE 9
Selected examples of nanoparticulate stabilizers
for poly-L-, -D- and -D,L-lactic acids

| Stabilizer | | | | |
|---|---|---|---|---|
| example | Carrier material | Stabilizer | Solvent | Use |
| 4.1 | AEROSIL R 106 | UKANOL DOP | toluene | iii) |
| 4.2 | ″ | tropolone | toluene | iii) |
| 4.3 | AEROSIL 300 | UKANOL DOP | acetone | iii) |
| 4.4 | AEROSIL COK 84 | tropolone | toluene | iii) |
| 4.5 | ″ | UKANOL DOP | toluene | iii) |
| 4.6 | AEROXID Alu C | tropolone | toluene | iii) |
| 4.7 | ″ | UKANOL DOP | toluene | iii) |

UKANOL DOP: 9,10-dihydro-9-oxa-10-phosphaphenanthrene-10-oxide

### Example 2

### Polycondensation

1060 g of a 85% L-lactic acid (experimental product of the applicant) are completely dehydrated in a glass apparatus equipped with a stirrer, an external heater and a temperature-controlled Vigreux column in vacuum at 155° C. within 2 h, the vacuum being controlled so that no lactic acid is carried off via the distillate. After the dehydration phase, the temperature is increased to 185° C., and polycondensation is conducted for 4 h at 13 kPa with the addition of Catalyst 1.4 (dihydroxy-bis-(ammoniumlactato)-titanium Tyzor® LA/AEROSIL 300) (5 ml of dispersion with 10⁻⁴ mol of catalyst/mol of lactic acid). The yield, molar mass and [COOH] content of the polycondensation product are determined.

### Yield: 700 g

Mₙ: 2,600 g/mol
[COOH]: 0.3 mmol/g

### Example 3

### Polycondensation

900 g of an anhydrous L-lactic acid (experimental product of the applicant) are polycondensed for 3 h in a glass apparatus equipped with a stirrer, an external heater and a temperature-controlled Vigreux column in vacuum at temperatures of 150-210° C. in the presence of 5 g of Catalyst 1.2 (isopropyl-tri(dioctylphosphato)-titanate) (KR 38 S, AEROSIL R 106) (3*10⁻⁴ mol catalyst per mol lactic acid). The temperature and vacuum program is adjusted to not carry off any lactic acid via the distillate. The product is completely dehydrated in vacuum at 155° C. within 2 h. The final vacuum chosen is 13 kPa. By analogy with Example 2, the yield, molar mass and [COOH] content of the polycondensation product are determined.

### Yield: 730 g

Mₙ: 3,600 g/mol
[COOH]: 0.3 mmol/g

### Example 4

### Polycondensation

In analogy to Example 2, 1060 g of a 85% L-lactic acid (experimental product of the applicant) are completely dehydrated in vacuum at 155° C. within 2 h and subsequently heated to 200° C. and polycondensed for 2 h with the addition of Catalyst 1.8 (dihydroxy-bis-(ammoniumlactato)-titanium Tyzor® LA/SnCl₂/AEROSIL COK 84) (15 ml of dispersion with 2*10⁻⁴ mol Tyzor® LA/3*10⁻⁴ mol of SnCl₂/mol of lactic acid).

### Yield: 700 g

Mₙ: 4,200 g/mol
[COOH]: 0.1 mmol/g

### Example 5

### Polycondensation

In a liquid-heated 25 I laboratory stirred tank equipped with an anchor agitator, a jacket heater, a bottom valve and a temperature-controlled column as well as with jacket interior and exterior temperature detection, 15 kg of a 65% L-lactic acid are dehydrated in vacuum at 120 to 160° C. (vapor-controlled temperature program) and subsequently polycondensed for 4 h at 190° C. in the presence of Catalyst 1.10 (dihydroxy-bis-(ammoniumlactato)-titanium Tyzor LA/SnCl₂/AEROSIL 300) (30 g of solid with 2*10⁻⁴ mol Tyzor® LA/3*10⁻⁴ mol of SnCl₂/mol of lactic acid).

### Yield: 7.5 kg

Mₙ: 5,800 g/mol
[COOH]: 0.1 mmol/g

### Example 6

### Polycondensation

In analogy to Example 2, 920 g of a commercially available D,L-lactic acid are polycondensed with the addition of Catalyst 1.10 (dihydroxy-bis-(ammoniumlactato)-titanium Tyzor LA/SnCl₂/AEROSIL 300) (5 ml of dispersion with 2*10⁻⁴ mol Tyzor® LA/3*10⁻⁴ mol of SnCl₂/mol of lactic acid) and worked up. By analogy with Example 2, the yield, molar mass and [COOH] content of the polycondensation product are determined.

### Yield: 700 g

Mₙ: 4,800 g/mol
[COOH]: 0.1 mmol/g

### Example 7

### Polytransesterification

1180 g of an ethyl-L-lactate (experimental product of the applicant) are polycondensed in a glass apparatus equipped with a stirrer, an external heater and a temperature-controlled Vigreux column at 200° C. in the presence of Catalyst 1.4 (dihydroxy-bis-(ammoniumlactato)-titanium Tyzor® LA/AEROSIL 300) (15 ml of dispersion with 3*10⁻⁴ mol of catalyst/mol of lactic acid). Separated ethanol is removed via the column and may be directly reused for the esterification of L-lactic acid. For a complete separation of ethyl ester groups, the reaction is completed under vacuum after removal of the main part of ethanol formed.

### Yield: 700 g

Mₙ: 3,500 g/mol
[COOH]: 0.1 mmol/g

### Example 8

### Cyclizing Depolymerization

720 g of a poly-L-lactic acid produced according to Examples 2 to 5 are heated in a glass apparatus equipped with a stirrer, an external heater and a temperature-controlled packed column with a likewise temperature-controlled cooler under a vacuum of 1.3−2.0 kPa in the presence of Catalyst 2.1 (SnCl₂/AEROSIL 300) (5 ml of dispersion with 3*10⁻⁴ mol of catalyst/mol of monomer unit). Depending on the selected depolymerization rate, the reaction mixture is then heated to 185-220° C., and L,L-dilactide formed is removed via the column, while the cooler temperature is held at 100° C. to avoid crystallization. Depolymerization is discontinued after approx. 80% turnover in order to avoid cracking of the polymer melt that leads to the creation of undesired degradation products in the polymer melt. Thus, the apparatus can be easily emptied or a new polymer melt can be charged and the depolymerization continued without the addition of a fresh catalyst.

### Yield: 570 g

### Example 9

### Cyclizing Depolymerization

In analogy to Example 8, 720 g of a poly-L-lactic acid produced in the presence of Catalyst 1.8 (Tyzor LA/SnCl₂/AEROSIL COK 84) or 1.10 (Tyzor LA/SnCl₂/AEROSIL 300) can be depolymerized without further addition of a catalyst.

### Yield: 560 g

### Example 10

### Purification of Raw Dilactides

Depending on the substrate and the selected depolymerization conditions, raw L,L-dilactides with the carboxyl group contents and angles of rotation [α] shown in Tables 2 and 3 are obtained.

For fine purification, the raw lactides are distilled in vacuum or are recrystallized from acetic ethyl ester in the presence of CaCO₃ as acid acceptor in order to separate residual lactic acid, linear oligomers and residual water. The L,L-dilactide for bulk polymerization thus purified by distillation or crystallization is characterized by:

### Tₘ: 96 to 97° C.

[α]: −268 to −270°
[COOH]: 8 μmmol/g

D,L-dilactide purified by distillation or crystallization has the following data:

### Tₘ: 126 to 127° C.

[COOH]: 10 μmmol/g

### Example 11

### Ring-Opening Polymerization, Discontinuous in a Cylindrical Glass Container

36 g of an L,L-dilactide produced according to Examples 8 or 9, purified according to Example 11 and carefully dried are melted in a cylindrical glass reactor equipped with a wall-to-wall screwed blade stirrer (propeller agitator) under inert gas in a tempering bath. The propeller agitator made of glass and reaching down to the bottom axially intermixes the melt. The agitator is operated with a rotational speed of 100 min⁻¹. After reaching the required temperature, 1 ml of Catalyst Dispersion 3.1 (Sn(oct)₂/AEROSIL R 106 in toluene; corresponding to 7.5*10⁻⁵ mol/mol of Sn(oct)₂/mol of monomer unit) is added to the stirred monomer melt. For determining the polymerization progress, samples of the melt can be taken via a lateral access to determine their monomer turnovers and molar masses. The determination of the turnover was conducted gravimetrically by reprecipitating polylactic acids from chloroform as solvent and a methanol/diethyl ether mixture as precipitating agent. The molar masses were determined by means of GPC in CH₂Cl₂. For calibration, polystyrene standards were used.

After a polymerization time of 20 min, the following was determined:

Monomer turnover: U=94
Molar mass: Mₙ=60,000 g/mol
Molecular polydispersity: Mₙ/M_{w}=2.1

### Example 12

### Ring-Opening Polymerization, Discontinuous in a Cylindrical Glass Container

In analogy to Example 11, 36 g of a purified L,L-dilactide are polymerized in the presence of 1 ml of Catalyst Dispersion 3.6 (Sn(oct)₂/titanium tetrabutylate/AEROSIL R 106 in toluene; corresponding to 1.5*10⁻⁴ mol of catalyst combination/mol of monomer unit) and worked up. After a polymerization time of 20 min, the following was determined:

Monomer turnover: U=96
Molar mass: Mₙ=75,000 g/mol
molecular polydispersity: Mₙ/M_{w}=2.0

### Example 13

### Ring-Opening Polymerization, Continuous in a Twin-Screw Extruder

For continuous mass polymerization of an L,L-dilactide in the form of a reactive extrusion process, a corotating and closely intermeshing twin-screw extruder with interior temperature and torque control was used. The twin-screw extruder used has an (L/D) ratio of 35 and screws with a modular design so that the screw configuration regarding transport, kneading and baffle elements can be optimally adjusted to process conditions and end product parameters.

1,000 g of an L,L-dilactide in the form of a crystalline powder, dried in a vacuum-drying cabinet at 40° C. over P₄O₁₀, was intensively mixed with Catalyst 3.1 (Sn(oct)₂/AEROSIL 106) in the form of dry nanoparticles (5 g corresponding to 1.5*10⁻⁴ mol of catalyst/mol of monomer unit) in a laboratory tumble mixer. Dosing of the lactide/catalyst mixture was performed by means of volumetric dosing via dosing screws. The temperature profile in the extruder, adjusted by means of the heating zones, was between 180 and 205° C. The polymer melt discharged was supplied to a granulator via a conveyor belt with air cooling. After extraction, turnover and molar mass of the polymer were determined.

### Turnover: 94.0%

Mₙ: 72,000 g/mol
M_{w}: 130,000 g/mol

### Example 14

### Ring-Opening Polymerization, Continuous in a Twin-Screw Extruder

In analogy to Example 13, 1,000 g of an L,L-dilactide were supplied to a twin-screw extruder by means of volumetric dosing. Complementary to Example 13, the polymer melt was stabilized. Catalyst 3.1 (Sn(oct)₂/AEROSIL 106) and Stabilizer 4.1 (UKANOL DOP/AEROSIL 106) were, in the form of their dispersions in toluene, separately supplied by means of micro-dosing pumps to the monomer (catalyst 25 ml corresponding to 7.5*10⁻⁵ mol/mol) or polymer melt (stabilizer 25 ml corresponding to 3*10⁻⁴ mol/mol) at spatially separated heating zones. In this experimental set-up, the removal of the residual monomer was achieved by means of vacuum demonomerization directly before discharge of the polymer melt from the extruder. In analogy to Example 13, the monomer-free polymer melt was supplied to a granulator via a conveyor belt. Turnover and molar mass of the polymer were determined directly.

### Turnover: 92.5%

Mₙ: 108,000 g/mol
M_{w}: 220,000 g/mol

1. A method for the production of high-molecular homo- and copolyesters of L-, D- and D,L-lactic acids that comprises the process steps of (i) polycondensation of a lactic acid or polytransesterification of esters thereof to a polymeric lactic acid, (ii) cyclizing depolymerization of the polymeric lactic acid to dilactides, and (iii) ring-opening polymerization of the dilactides or mixtures thereof with suitable comonomers,
wherein at least one of the process steps (i) to (iii) is performed in a heterogeneous reaction mixture, in the presence of at least one of a particulate catalyst and a particulate stabilizer, each having an average particle diameter of 1 to 100 nm.

2. The method according to claim 1 wherein at least one of a particulate catalyst and a particulate stabilizer is used in all process steps (i) to (iii).

3. The method according to claim 1 wherein the particulate catalyst or particulate stabilizer has an average particle diameter of 3 to 20 nm.

4. The method according to claim 1 wherein the particulate catalyst or particulate stabilizer comprises a particulate inorganic oxide as a carrier material.

5. The method according to claim 4 wherein the particulate inorganic oxide is silica, alumina or a mixture thereof.

6. The method according to claim 4 wherein the particulate catalyst or particulate stabilizer is hydrophobic, and the carrier material is hydrophobic.

7. The method according to claim 4 wherein the particulate catalyst or particulate stabilizer is hydrophilic, and the carrier material is hydrophilic.

8. The method according to claim 4 wherein the particulate catalyst is used that comprises at least one organic or inorganic metal compound adsorbed to the carrier material.

9. The method according to claim 8 wherein the at least one organic or inorganic metal compound is selected from the group consisting of titanium, zirconium and tin compounds.

10. The method according to claim 4 wherein process step (i) is performed in the presence of a particulate catalyst that has, as a metal compound adsorbed to the carrier material, hydrolysis-stable complexes of titanium or zirconium having the following structure:

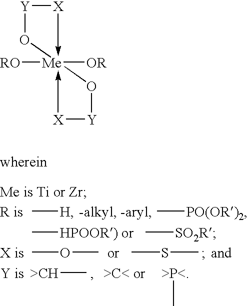

11. The method according to claim 10 wherein the complexes of titanium or zirconium have further functionalities on the selected ligands.

12. The method according to claim 10 wherein the hydrolysis-stable complexes are chelate complexes of titanium or zirconium in combination with tin(II) halides.

13. The method according to claim 8 wherein process step (ii) is carried out in the presence of a particulate catalyst is used that comprises, as a metal compound adsorbed to the carrier material, at least one compound selected from the group consisting of tin(II) halides and tin(II) carboxylates.

14. The method according to claim 8 wherein process step (iii) is carried out in the presence of a particulate catalyst that comprises, as a metal compound adsorbed to the carrier material, at least one compound selected from the group consisting of organic tin(II) and tin(IV) compounds.

15. The method according to claim 14 wherein the particulate catalyst comprises, as the metal compound adsorbed to the carrier material, at least one organic tin(II) or tin(IV) compound in combination with at least on titanium(IV) alkoxide.

16. The method according to claim 4 wherein the particulate stabilizer comprises at least one of a phosphorus compound and a complexing agent for tin(II) and tin(IV) compounds adsorbed to a carrier material.

17. The method according to claim 16 wherein the particulate stabilizer comprises at least one phosphorus compound is used that is a phosphinic acid or a derivative thereof.

18. The method according to claim 17 wherein the phosphinic acid or the phosphinic acid derivative is selected from the group consisting of alkyl and aryl phosphinic acids and derivatives thereof.

19. The method according to claim 18 wherein the phosphinic acid derivative is 9,10-dihydro-9-oxa-10-phosphaphenanthrene-10-oxide.

20. The method according to claim 16 wherein the complexing agent comprises tropolone or a derivative thereof.

21. The method according to claim 1 further comprising, before or during the process steps (i) to (iii), at least one step for preventing the agglomeration of the particulate catalyst or particulate stabilizer.

22. The method according to claim 21 wherein the step for preventing agglomeration comprises a surface treatment of the particulate catalyst or particulate stabilizer.

23. The method according to wherein the dilactides obtained in process step (ii) are purified by rectification, melt or solution crystallization before process step (iii) is conducted.

24. The method according to claim 1 wherein structurally equal or structurally different comonomers are copolymerized in process step (iii).

25. The method according to claim 24 wherein L,L-dilactide, D,D- or meso-dilactide are copolymerized as structurally equal comonomers in process step (iii).

26. The method according to claim 24 wherein diglycolide, trimethylene carbonate or c-caprolactone are copolymerized as structurally different comonomers in process step (iii).

27. The method according to claim 1 wherein all process steps are conducted continuously in stirred reactors or kneaders comprising discharge screws.

28. The method according to claim 1 wherein at least one process step is conducted discontinuously in twin-screw extruders.
